(19) United States
(12) Patent Application Publication
(10) Pub. No.: US 2010/0029106 A1
(43) Pub. Date: Feb. 4, 2010

(54) SOCKET WITH CONTACT FORMED BY METAL HAULM

(75) Inventors: SHIH-WEI HSIAO, Tu-Cheng (TW); HSIU-YUAN HSU, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/511,249

(22) Filed: Jul. 29, 2009

(30) Foreign Application Priority Data
Jul. 29, 2008 (TW) 97213407

(51) Int. Cl. H01R 12/00

(52) U.S. Cl. 439/78

(57) ABSTRACT

A socket, adapted for electrically connecting an IC package and a printed circuit board, comprises an upper housing, a lower housing and a plurality of contacts received between the upper housing and the lower housing. The contact is formed from a metal haulm and extends beyond a top surface of the upper housing for contacting with the IC package and a bottom surface of the lower housing for contacting with the printed circuit board, respectively. The contact has a main body, which is formed by twisting up the metal haulm to have a helical shape.

### BACKGROUND OF THE INVENTION

1. Field of the invention

The present invention relates to a socket for connecting an IC package and a printed circuit board, and more particularly to a socket having contacts formed by metal haulm.

2. Description of Related Art

US patent application publication No. 2008/0064236 discloses a contact for electrically connecting an IC package and a printed circuit board. The contact comprises an upper contact, a lower contact engaging with the upper contact and a spring disposed between the upper contact and the lower contact. The contact is formed with a main body with a pin shape configuration, two projecting portions projecting outwardly from two opposite sides of an upper part of the main body, and an upper contacting portion formed above the main body and used for contacting the IC package. The lower contact has a base portion, a lower contacting portion formed below the base portion, two protrusions projecting outwardly from two opposite sides of a lower part of the base portion and a pair of elastic arms extending upwardly from the base portion. The elastic arms have an arch shape and stretch toward each other. When assembling the contact, the spring firstly surrounds the lower contact, then the base portion is inserted between the pair of elastic arms of the upper contact and is clamped by the elastic arms; the spring is limited between the projecting portions of the upper contact and the protrusions of the lower contact. The upper contact and the lower contact can move on a top-to-bottom direction relative to each other and compress the spring at the same time. However, the contact has a complex configuration with three separated elements, furthermore the upper contact and the lower contact are usually formed by stamping, that cause a high cost of the contact.

Hence, an improved socket is required to overcome the above-mentioned disadvantages of the related art.

### SUMMARY OF THE INVENTION

Accordingly, an object of the present invention is to provide a contact which has a simple configuration and can be easily produced.

To achieve the aforementioned objects, a socket, adapted for electrically connecting an IC package and a printed circuit board, comprises an upper housing defining a plurality of first passageways, a lower housing defining a plurality of second passageways, and a plurality of contacts received between the first passageways and the second passageways. Each contact is formed from a metal haulm and has an upper contacting portion extending beyond a top surface of the upper housing for contacting with the IC package, and a lower contacting portion extending beyond a bottom surface of the lower housing for contacting with the printed circuit board. The contact further has a main body, which is formed by twisting up the metal haulm to have a helical shape.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is an assembled, perspective view of a socket in accordance with present invention;

FIG. 2 is similar with FIG. 1, but taken from a bottom side;

FIG. 3 is an explored, perspective view of the socket;

FIG. 4 is similar with FIG. 3, but taken from the bottom side;

FIG. 5 is a perspective view of a contact of the socket; and

FIG. 6 is a sectional view of the socket.

### DETAILED DESCRIPTION OF THE INVENTION

Reference will now be made to the drawings to describe the present invention in detail.

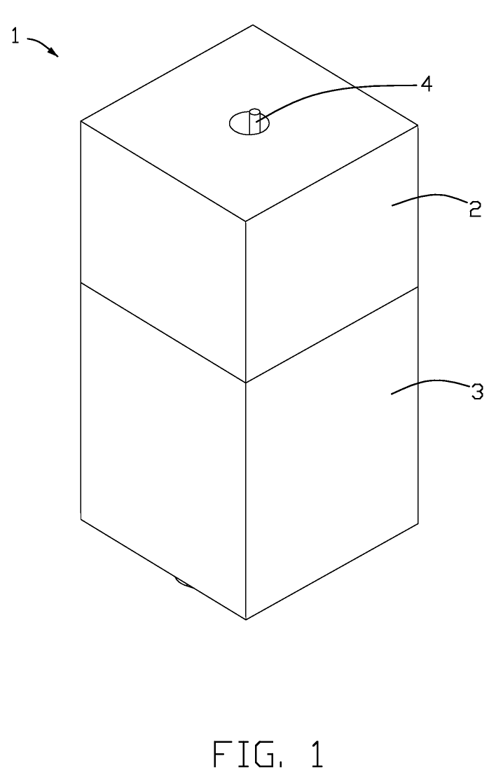

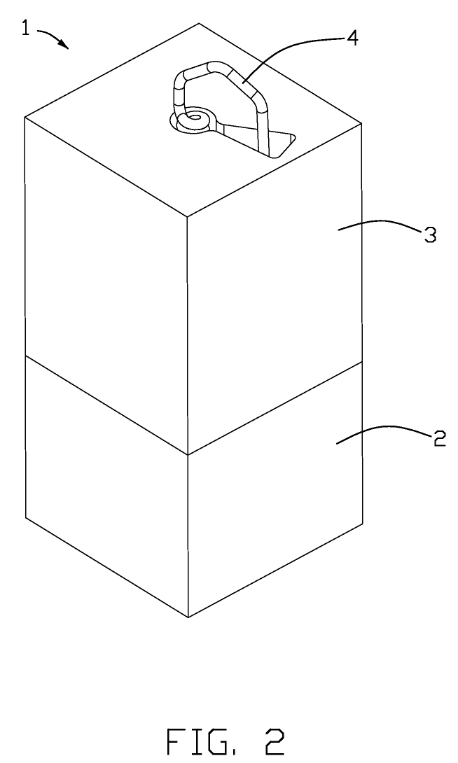

Referring to FIG. 1 to FIG. 2, showing a preferred embodiment of present invention, only a part of a socket 1 is shown. The socket 1, adapted for electrically connecting an IC package (not shown) and a printed circuit board (not shown), has an upper housing 2, a lower housing 3 and a contact 4 disposed between the upper housing 2 and the lower housing 3. A top end and a bottom end of the contact 4 extend beyond the upper housing 2 and the lower housing 3, respectively, for contacting with the IC package (not shown) and the printed circuit board (not shown), respectively.

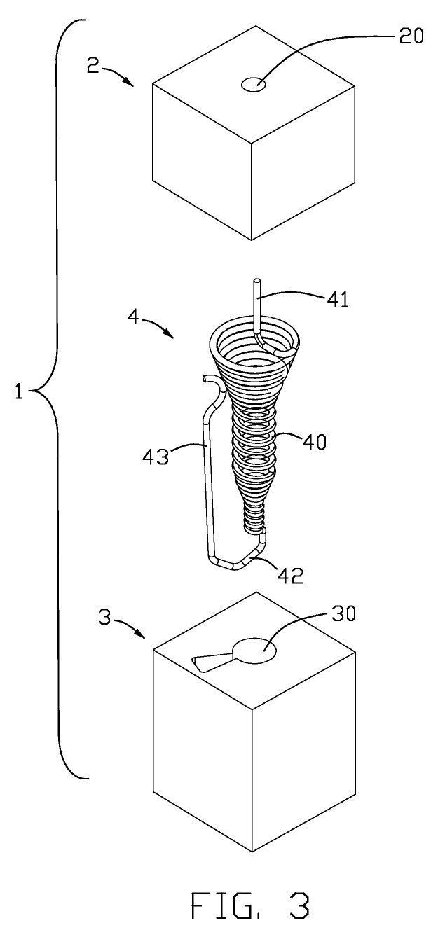

Referring to FIG. 3, an explored, perspective view of the socket 1, the upper housing 2 defines a plurality of first passageways 20, the lower housing 3 correspondingly defines a plurality of second passageways 30, the contacts 4 are received in the first passageways 20 and the second passageways 30 and located between the upper housing 2 and the lower housing 3. The contact 4 is formed from a metal haulm, which comprises an upwardly helical main body 40 by twisting up the metal haulm, a first free end 41 extending upwardly from the top of the main body 40, a bent portion 42 extending upwardly from the bottom of the main body 40, an arm portion 43 extending from the bent portion 42 and a second free end 44 formed on an end of the arm portion 43.

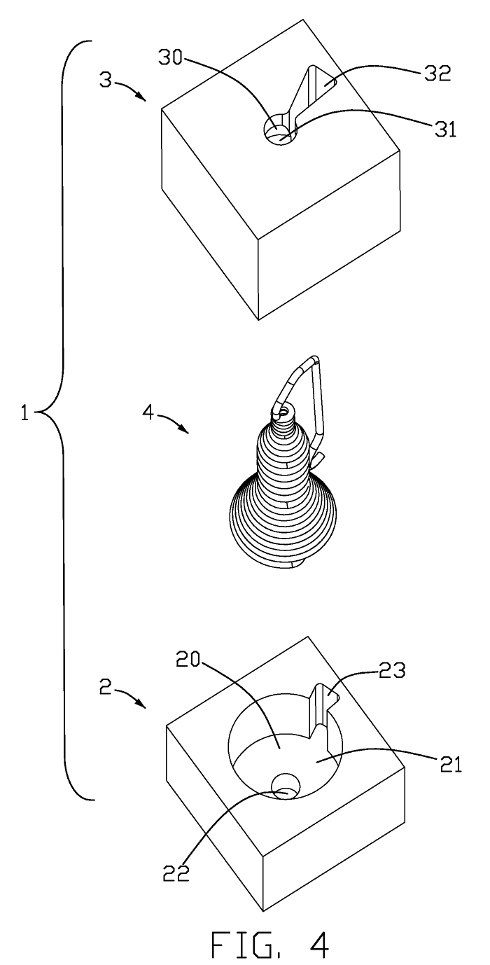

Referring to FIG. 4, another explored, perspective view of the socket 1 is provided to clearly show the first contact passageway 20 of the upper housing 20 and the second passageway 30 of the lower housing 30. The first passageway 20 of the upper housing 2 comprises a columnar receiving cavity 21 which opens on a bottom surface of the upper housing 2, a through hole 22 passing through a top surface of the upper housing 2 from the middle of the receiving cavity 21 and a vertical slot 23 passing through the bottom surface of the upper housing 2 and communicating with the receiving cavity 21. The second passageway 30 has a circular aperture 31 and a narrow channel 32, both of the aperture 31 and the channel 32 pass through the lower housing 3.

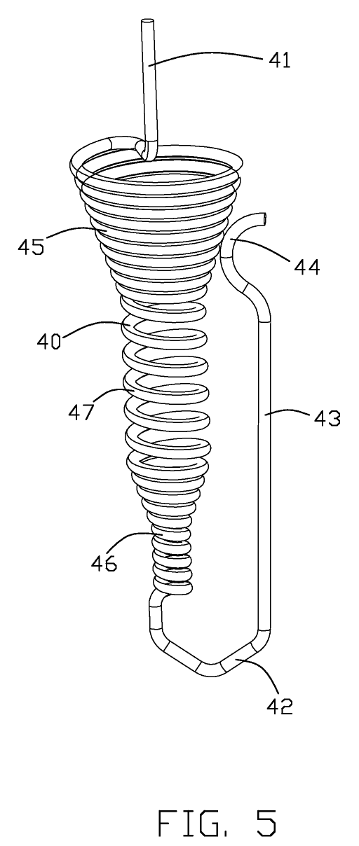

Referring to FIG. 5, showing the contact 4 in a compressed state, the helical main body 40 of the contact 4 has three parts: a first part 45 in the top, a second part 46 on the bottom and an elastic part 47 connecting the first part 45 and the second part 46. The first part 45 has a substantially coniform shape with gradually increased diameters along a bottom-to-top direction, the second part 46 has the smallest diameter of the main body 40. The elastic part 47 has a columnar shape with an equal diameter, which is smaller than that of the first part 45 and larger than that of the second part 46. The first part 45 and the second part 46 have compact rings, which substantially will not have deformations when the contact 4 is compressed; while the elastic 47 has loose rings relative to the first part 45 and the second part 46 and easily deforms. When the contact 4 is compressed, most of deformations of the contact 4 occur on the elastic part 47, and a restoring elastic force of the elastic part 47 brings the contact 4 return to the original and natural state.

The bent portion 42 below the main body 40 extends downwardly and then upwardly to have a V-shape, the arm portion 43 is bent upwardly from the bent portion 42 and extends upright to close the first part 45. The second free end 44 on the end of the arm portion 43 is an arch configuration projecting toward the first part 45. The second free end 44 is pushed outwardly and abuts against by the first part 45 when the contact 4 is compressed and the first part 45 moves downwardly.

The first free end 41 above the main body 40 provides an upper contacting portion contacting with the IC package (not shown), the bent portion 42 provides a lower contacting portion contacting with the printed circuit board (not shown), and the contacting points formed by the upper contacting portion and the lower contacting portion, respectively, have an offset in a vertical direction.

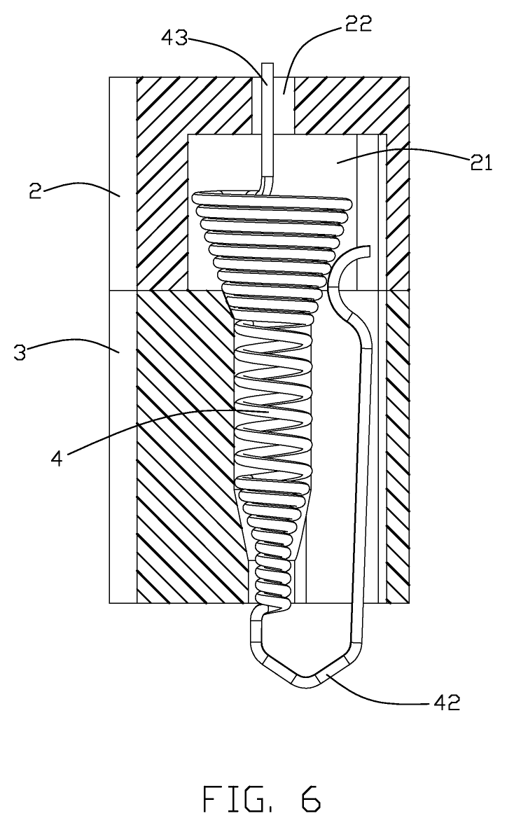

Referring to FIG. 6, showing the contact 4 received between the upper housing 2 and the lower housing 3, similar with FIG. 5, when the contact 4 is compressed, the first part 45 of the contact 4 is received in the receiving cavity 21 of the upper housing 2; the free end 44 extends beyond the top surface of the upper housing 2 by passing through the through hole 22; the second part 46 is received in the circle aperture 31 of the lower housing 3; most part of the elastic part 47 is located in the aperture 31, however, when the contact 4 is in the original and natural state, a small top part of the elastic part 47 also may be located in the receiving cavity 21 of the upper housing 2; the bent portion 42 projects beyond the bottom surface of the lower housing 3; the arm portion 43 is substantially located in the channel 32, the second free end 44 on the end of the arm portion 43 enters into the slot 23 of the upper housing 2.

The IC package (not shown) compresses the first free end 41 of the contact 4 and makes the elastic part 47 deform, the first part 45 moves downwardly, then abuts against and pushes the second free end 44 outwardly, thus, the first part 45 can tightly contacts with the second free end 44 to build a shot electrical transmitting path, so that a signal from the IC package (not shown) arrives the printed circuit board (not shown) by passing through the arm portion 43 and the bent portion 42, and the signal does not need to pass through the elastic part 47 and the second part 46 of the main body 40, so the contact 4 has a lower resistance.

The contact 4 is a single element, so it has a simple configuration, a lower cost, and an easy assembling process relative to conventional contact including an upper contact, an lower contact and a spring.

However, the disclosure is illustrative only, changes may be made in detail, especially in matter of shape, size, and arrangement of parts within the principles of the invention.

What is claimed is:

1. A socket, adapted for electrically connecting an IC package and a printed circuit board, comprising:
an upper housing, defining a plurality of first passageways;
a lower housing, defining a plurality of second passageways; and
a plurality of contacts formed from a metal haulm and received between the first passageways and the second passageways, each contact having an upper contacting portion extending beyond a top surface of the upper housing for contacting with the IC package, a lower contacting portion extending beyond a bottom surface of the lower housing for contacting with the printed circuit board and a main body, the main body formed by twisting up the metal haulm to have a helical shape.

2. The socket as claimed in claim 1, wherein the contact has a first free end extending upwardly from the top of the main body and providing the upper contacting portion, and a bent portion extending downwardly from the bottom of the main body and providing the lower contacting portion.

3. The socket as claimed in claim 2, wherein the main body has an elastic part, which deforms when the contact is compressed.

4. The socket as claimed in claim 2, wherein the bent portion extends downwardly and then upwardly from the bottom of the main body.

5. The socket as claimed in claim 4, wherein the contact further has an arm portion extending upwardly from the bent portion and providing a second free end.

6. The socket as claimed in claim 5, wherein the main body has a first part, a second part and an elastic part connecting the first part and the second part, the first part has a substantially coniform helical shape with gradually increased diameters along a bottom-to-top direction, while the second part has a smallest diameter of the main body.

7. The socket as claimed in claim 6, wherein the first passageway of the upper housing comprises a receiving cavity for receiving the first part, and a through hole for the first free end to pass through the top surface of the upper housing.

8. The socket as claimed in claim 7, wherein the first passageway of the upper housing has a vertical slot receiving the second free end.

9. The socket as claimed in claim 6, wherein the second passageway comprises an aperture receiving the elastic part and the second part, and a channel receiving the arm portion, the bent portion passes through the second passageway and protrudes beyond the lower housing.

10. A contact of socket, formed from a metal haulm, comprising:
a main body having a helical configuration and being retractable;
a first free end, extending upwardly from the top of the main body;
a bent portion, extending downwardly from the bottom of the main body; and
an arm portion, extending upwardly from the bent portion and providing a second free end on an end thereof.

11. The contact of socket as claimed in claim 10, wherein the main body comprises a first part, a second part and an elastic part connecting the first part and the second part, the first part has a substantially coniform shape with gradually increased diameters along a bottom-to-top direction, the second part has a smallest diameter of the main body.

12. The contact of socket as claimed in claim 9, wherein when the contact is compressed, the elastic part deforms and the first part moves downwardly, then the arm portion abuts against and electrically contacts the first part.

13. An electrical connector comprising:
an insulative housing defining two opposite first and second mating surfaces with a passageway therebetween;
a conductive contact received in the passageway and formed by winding a round wire with a spiral manner with opposite first and second end sections moveable around the corresponding first and second mating surfaces, respectively, the first end section of said contact extending beyond the corresponding first mating surface and further backwardly curved to have a corresponding tip engageably move in the passageway along a main body of said contact when said first end section is pressed by a corresponding electronic component which is located close to and faces toward the first mating surface.

14. The electrical connector as claimed in claim 13, wherein the spiral main body of the contact defines at least large segments with respective large and small diameters along an axial direction thereof, and the first end section extends from the small segment.

15. The electrical connector as claimed in claim 14, wherein the passageway is configured to be equipped with two different portions of different large and small diameters along said axial direction to comply with the corresponding large and small segments, respectively.

16. The electrical connector as claimed in claim 14, wherein said main body is further provided with another segment linked to the large segment, and the second end section extends from said another segment and above the second mating surface.

17. The electrical connector as claimed in claim 16, wherein said another segment is diametrically larger than the large segment.

18. The electrical connector as claimed in claim 17, wherein said the tip of the first end section is seated upon said another segment.

19. The electrical connector as claimed in claim 13, wherein said housing is formed by two halves providing the first and second mating surfaces thereon, respectively.
